(19) United States
(12) Patent Application Publication
(10) Pub. No.: US 2006/0155957 A1
(43) Pub. Date: Jul. 13, 2006

(54) Encoding method for very long instruction word (VLIW) DSP processor and decoding method thereof

(75) Inventors: Tse-Hao Lee, Hsinchu (TW); I-Tao Liao, Hsinchu (TW); Tay-Jyi Lin, Hsinchu (TW); Ming-Lun Liu, Hsinchu (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/242,785

(22) Filed: Oct. 5, 2005

(30) Foreign Application Priority Data
Dec. 29, 2004 (TW) 93141219

(51) Int. Cl. G06F 15/00

(52) U.S. Cl. 712/24

(57) ABSTRACT

An encoding method for a very long instruction word (VLIW) DSP processor and decoding method thereof. The encoding method involves a plurality of first encoding portions and a plurality of second encoding portions. The first encoding portions and second encoding portions are complied from an instruction. The first encoding portions are sequentially arranged after an instruction package CAP, and the second encoding portions are sequentially arranged after the first encoding portions.

This application claims the benefit of Taiwan Patent Application No. 93141219, filed on Dec. 29, 2004, which is hereby incorporated by reference for all purposes as if fully set forth herein.

### BACKGROUND

1. Field of Invention

The invention relates to an encoding method of an instruction set, and in particular to an encoding method for a very long instruction word (VLIW) DSP processor.

2. Related Art

Current multimedia systems employ a microprocessor together with a digital signal processor and some hardware accelerators for signal processing. The microprocessor controls some programs, while the digital signal processor and hardware accelerators perform digital signal processing, which is more complicated. Although employing the hardware accelerators involves a more mature design process and lower cost, the importance of the hardware accelerators can not compete with the programmable digital signal processor under the rapid development of digital multimedia applications.

Conventional digital signal processors provide higher calculation capability than microprocessors. The single pipeline architecture is developed toward the superscalar architecture or very long instruction word (VLIW) architecture with the increasing need for calculation capability.

Under the prevalent trend of handset devices, the Digital signal processors not only provide high calculation capability, but also meet the need to reduce power consumption, which have both become keys to dominating the market. The superscalar architecture sorts the instructions when the program is executing, while the very long instruction word architecture sorts the instructions when the program is compiling. From the point of view of the architecture, the very long instruction word architecture is better at reducing power consumption than the superscalar architecture. However, NOP (No Operation) instructions caused by fixed length encoding and insufficient parallel degree of the instructions increase to a very large scale. This may also cause an insufficient memory usage rate of the VLIW architecture.

The prior art discloses an encoding method of variable length, as illustrated in FIG. 1. An end bit E is arranged at the end of each instruction INST. The length of each instruction INST is variable, and the end bit E represents the length of the instruction INST. However, obtaining the starting address of the next instruction may be difficult with this method. This is because multiple instructions of different lengths are decoded in one clock. Therefore, the encoding procedure lacks efficiency. FIG. 2 illustrates another encoding method, in which a starting bit S is included in the beginning of the instruction INST. Thus, all related instructions may be obtained by accessing the starting bit S. However, the encoding method in FIG. 1 and FIG. 2 waste spare bits for recoding instruction information.

FIG. 3 illustrates an encoding method by way of index, in which the instructions that may execute in parallel are listed in a table. The program code may obtain the index value by way of this table such that the size of the program code is reduced. Only operation instructions are stored in the table, thus NOP instructions do not occur. When the program is executing, the instructions are loaded into the internal memory of the processor according to the table, and then the index values are used for inquiry. However, because the instruction table is the internal state of the processor, all the instructions need to be backed up to external storage when interruption or exception occurs.

FIG. 4 illustrates another encoding method with variable length, in which a shorter instruction THUMB with fixed length (16 bits) is provided together with the instruction ARM with length (32 bits). When the information necessary for some program segments is fewer, the instructions of shorter length may be employed to reduce the size of the program code. Switching between two instructions is executed by way of interrupting or calling. However, the instruction decoder has to decode instructions with different lengths, thus complexity is increased. Furthermore, only two lengths may be adopted so flexibility is insufficient and the encoding efficiency is not good.

Another encoding method in which the length of each instruction is variable is also disclosed. The length is determined by the information carried in the instruction. However, the beginning of instruction alignment needs to be obtained first, and the complexity is increased when the length of the instruction is not fixed.

Therefore, another encoding method by way of HAT format is disclosed to solve this problem. Variable length is also employed in the instruction, which is divided into a first encoding portion (head) with fixed length and a second encoding portion (tail) with variable length. The length of the second encoding portion is recorded in the first encoding portion. Then each first encoding portion of each instruction is arranged from left to right, and each second encoding portion of each instruction is arranged from right to left, as illustrated in FIG. 5. Multiple instructions with different lengths are bundled in an instruction bundle with fixed length. However, the beginning of the second encoding portion is determined until the size of the second encoding portion recorded in the former instruction is decoded. When there are multiple instructions executing in parallel, the cortical path is too long to be feasible.

Another encoding method adopts HAT format in VLIW architecture, in which two-layer HAT format is employed to reduce the size of the program code. The first layer uses HAT-format encoding, in which each instruction is encoded with variable length and head-tail for bundling the instructions that may execute in parallel in the instruction bundle having variable length. The instruction bundle is used as a basic unit in the second layer, in which a first encoding portion with fixed length and a second encoding portion are bundled as a super bundle by way of HAT format. The slots of NOP are categorized into several formats such that the length of the instruction is effectively compressed. However, some unused bits occur in each super bundle, and the size of the super bundle may increase response time when a branch occurs. Furthermore, the problem of the long critical path is not improved in this method. Another encoding method also adopts two-layer HAT format, in which related encoding information is included in the Head of the first layer such that the critical path is shortened. However, each super bundle still has the problem of usage rate. When the bandwidth provided by the instruction memory is insufficient, the branch instruction may be delayed.

Therefore, simplification of the instruction encoding and increase of the effective calculations provided by the instruction word has been the main consideration for high performance processors. Meanwhile, assigning an instruction prompt has also become an important research topic. However, the prior art does not provide an effective solution to the problem.

### SUMMARY

Accordingly, the invention is related to an encoding method for a very long instruction word digital signal processing processor that substantially obviates one or more of the problems of the related art.

According to the embodiment of the invention, the encoding method for a very long instruction word digital signal processing processor includes a instruction package CAP; a plurality of first encoding portions; and a plurality of second encoding portions; the first encoding portions and the second encoding portions are compiled from an instruction; the first encoding portions are arranged after the instruction package CAP in sequence; and the second encoding portions are arranged after the first encoding portions in sequence.

According to the embodiment of the invention, the decoding method for a very long instruction word digital signal processing processor includes the steps of compiling at least one instruction including a instruction package CAP, a plurality of first encoding portions, and a plurality of second encoding portions, wherein the first encoding portions and the second encoding portions are compiled from an instruction, the first encoding portions are arranged after the instruction package CAP in sequence, and the second encoding portions are arranged after the first encoding portions in sequence; decoding the instruction package CAP in one clock, assigning the plurality of the first encoding portions according to the decoded instruction package CAP, and generating Program Counter for the next clock; in another clock, decoding the assigned first encoding portions, and obtaining the length of information of the first encoding portions; and assigning the plurality of the second encoding portions according to the length information and decoding the second encoding portions.

According to the embodiment of the invention, the encoding method has the advantage of a better instruction memory usage rate, and prevents overload of instruction assignment and decoding.

The HAT format encoding method is not easy to expand, while the disclosed encoding method is back compatible by using CAP, which is appropriated encoded.

The encoding method for a very long instruction word digital signal processing processor employs two-layer HAT format encoding. Each instruction package is directly stored in the instruction memory in sequence such that spotty bits caused by the super package are prevented. Furthermore, the bandwidth corresponding to the super package is not necessary for the instruction memory.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

### BRIEF DESCRIPTION OF THE DRAWINGS

The above and other objects, features and other advantages of the invention will be more clearly understood from the following detailed description when taken in conjunction with the accompanying drawings, in which:

FIG. 1 illustrates the encoding method of the prior art;

FIG. 2 illustrates the encoding method of the prior art;

FIG. 3 illustrates the encoding method of the prior art;

FIG. 4 illustrates the encoding method of the prior art;

FIG. 5 illustrates the encoding method of the prior art;

FIG. 6 illustrates one embodiment of the encoding method for a very long instruction word (VLIW) DSP processor in accordance with the invention;

FIG. 7 illustrates sorting of the instructions of the encoding method for a very long instruction word (VLIW) DSP processor in accordance with the invention;

FIG. 8 illustrates another embodiment of the encoding method for a very long instruction word (VLIW) DSP processor in accordance with the invention;

FIG. 9 illustrates another embodiment of the encoding method for a very long instruction word (VLIW) DSP processor in accordance with the invention;

FIG. 10 illustrates another embodiment of the encoding method for a very long instruction word (VLIW) DSP processor in accordance with the invention;

FIG. 11 illustrates another embodiment of the encoding method for a very long instruction word (VLIW) DSP processor in accordance with the invention; and

FIG. 12 illustrates the decoding process of the encoding method for a very long instruction word (VLIW) DSP processor in accordance with the invention.

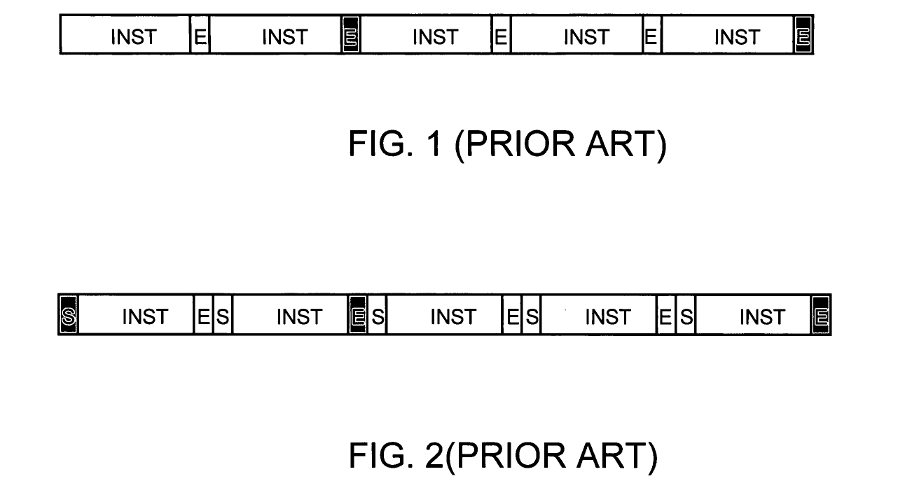

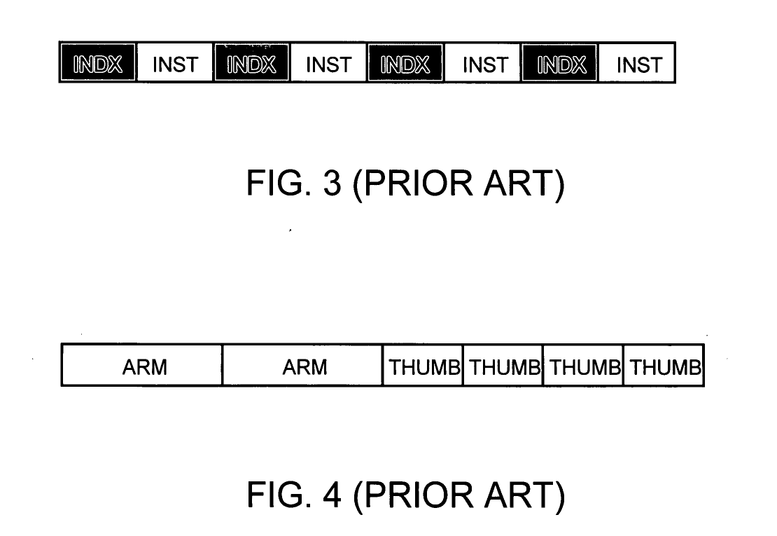

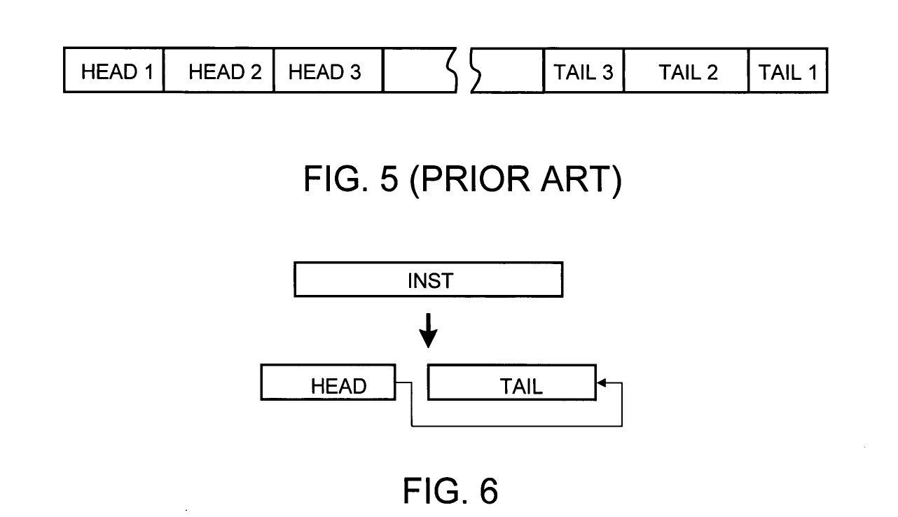

### DETAILED DESCRIPTION

Reference will now be made in greater detail to a preferred embodiment of the invention, an example of which is illustrated in the accompanying drawings. Wherever possible, the same reference numerals are used throughout the drawings and the description to refer to the same or like parts. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

FIG. 6 illustrates one embodiment of the encoding method for a very long instruction word (VLIW) DSP processor in accordance with the invention.

The disclosed encoding method compiles a single instruction INST with variable length as a first encoding portion HEAD and a second encoding portion TAIL. The length of the first encoding portion HEAD is fixed, while that of the second encoding portion TAIL is variable. The first encoding portion HEAD includes length information. The length unit of the second encoding portion TAIL is BYTE so that each instruction may align in the address by BYTE. Thus, the design of the instruction memory is simplified.

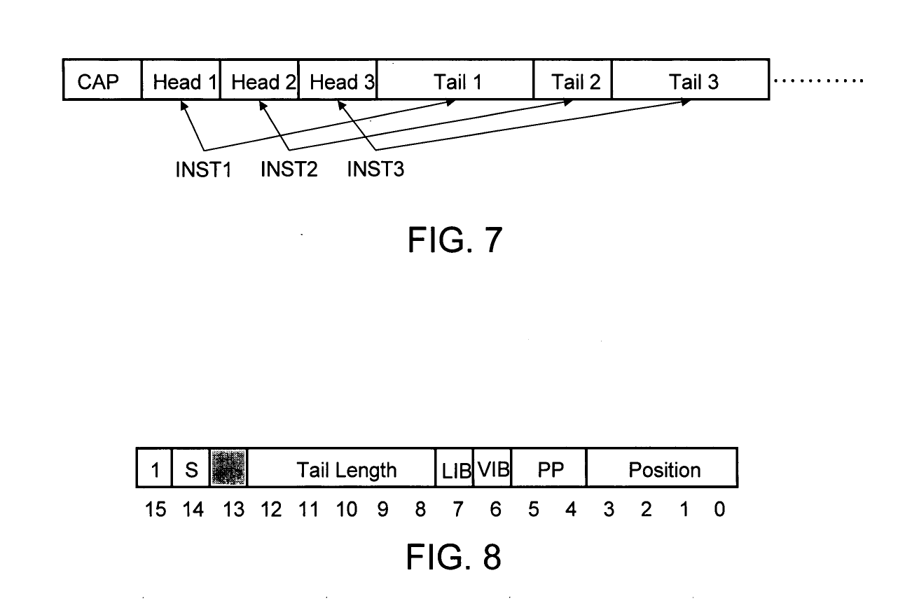

FIG. 7 illustrates instruction sorting when a plurality of instructions are executing. The first encoding portion HEAD and the second encoding portion TAIL of a single instruction are separated. The first encoding portions HEAD are arranged in sequence, then the second encoding portions TAIL are arranged in sequence. An instruction package CAP having encoding information is provided in front of the first encoding portion HEAD. For the embodiment in FIG. 7, three instructions are listed, in which the first encoding portions HEAD1, HEAD2, HEAD3 are first arranged, following by the second encoding portions TAIL1, TAIL2, TAIL3. In the embodiment, the instruction package CAP is followed by the first encoding portion HEAD which is followed by the second encoding portion TAIL.

The very long instruction word architecture may perform multiple instructions simultaneously, so multiple instructions with variable lengths exist in each clock. Thus, assigning instructions in each clock is the key to affect the performance. For example, the instruction package CAP has the information of package category, composition of the first encoding portion HEAD, the total length of the second encoding portion TAIL, and hardware. The package of each clock may be continuously placed in the instruction memory. Therefore, the usage rate of the instruction memory is increased, and the calculation of the branch targets is simplified.

FIG. 8 illustrates the format of the instruction package CAP, which is a general instruction package CAP occupying bytes with predetermined lengths, e.g. two bytes. The number in the bottom represents the bit address. The filed S and filed Position determine the composition of the following instructions. The filed Tail Length represents the total length of the second encoding porticos. The fields LIB, VIB are for instruction broadcast. The field PP is special hardware information, in which when the calculating unit supports a specialized register organization. The instruction may be reproduced in the assigning unit by way of instruction broadcast. Therefore, repeated instructions are reduced in the same clock.

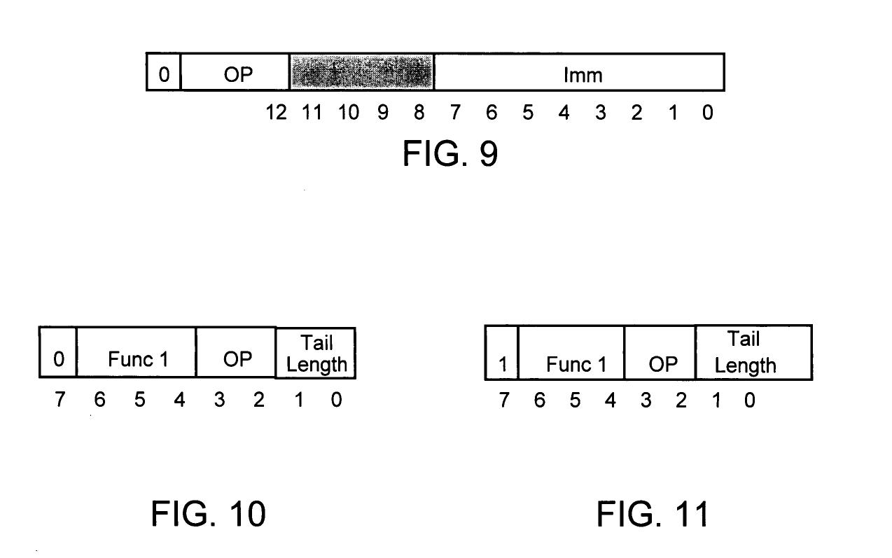

FIG. 9 illustrates another format of the instruction package CAP, which is a version compatible package. The information necessary for calculation is less than the general instruction package CAP. A version compatible instruction may be executed. Through the version compatible package, decoding settings may be included in the decoding process such that the processor of the new version may process the old machine code of the old version for backward compatible. Some necessary control instructions may also employ the version compatible package to encode. The filed OP is the version compatible operation code for determining which version compatible instruction it is. The filed Imm is the operand necessary for the version compatible instruction.

FIG. 10 illustrates another embodiment of the instruction package CAP, which is a program flow package having program executing flow. The information necessary for calculation is less than the general instruction package CAP. The length of the instruction package CAP is less than or equal to the bytes of predetermined length, e.g. one byte, which may be combined with the first encoding portion HEAD. The filed OP is the operation code of the program flow control instructions for determining which program flow control instruction it is. The field Func_1 is the executing mode of the program flow control instruction. The field Tail_Length is the length (byte) of the second encoding portion of the program flow control instruction.

FIG. 11 illustrates another embodiment of the instruction package CAP, which is the data calculation package during interrupt. Only part of the whole processor, e.g. the program sequence controller, provides calculation capability during interrupt, so fewer bits are necessary for loading information. The length of the instruction package CAP is less than or equal to the bytes with predetermined length, e.g., 1 byte. Because either the program flow package or data calculation package are in the program for each clock, and only one instruction is in the data calculation package, the instruction package CAP may combine with the first encoding portion HEAD. Thus, the data calculation instruction provided by the program sequence controller is encoded differently for general situations and interrupt service routines. The necessary memory for the interrupt service routine is reduced effectively. The filed OP is the operation code of the data calculation instructions during interrupt for determining which data calculation instruction it is. The field Func_1 is the executing mode of the data calculation instruction during interrupt. The field Tail_Length is the length (byte) of the second encoding portion of the data calculation instruction during interrupt.

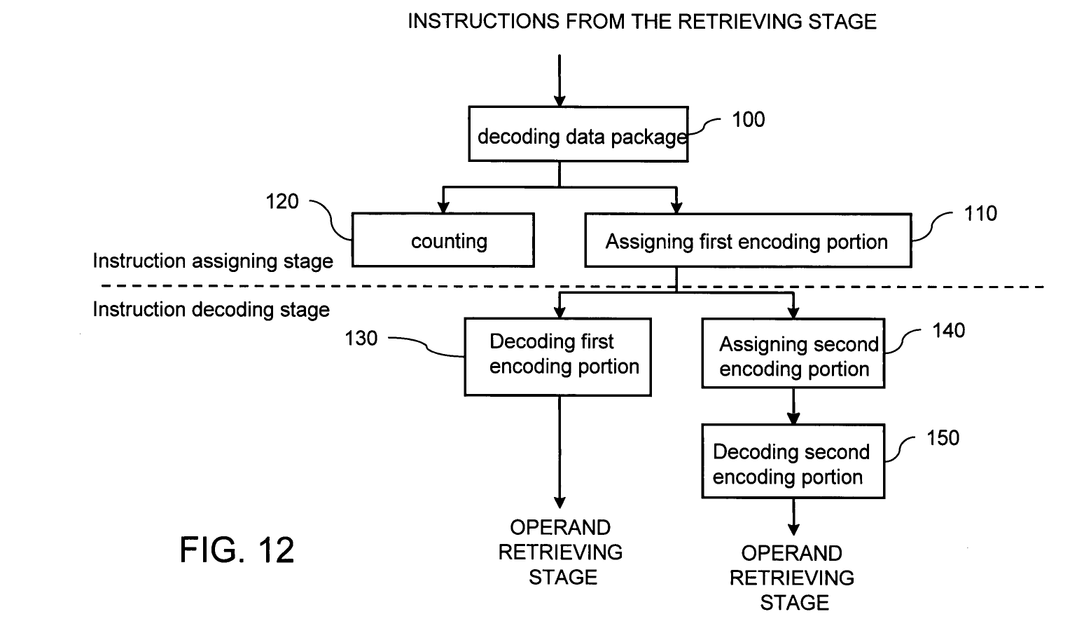

FIG. 12 illustrates the decoding process of the encoding method for a very long instruction word (VLIW) DSP processor in accordance with the invention. After retrieving the instructions, the instruction package CAP is decoded in the instruction assigning unit (step 100), and the obtained information is used to assign the first encoding portion HEAD (step 110). Program Counter for the next clock is also generated (step 120). The assigned first encoding portions HEAD and un-assigned second encoding portions TAIL are delivered to the instruction decoding unit. The instruction decoding unit processes the instructions of the former clock delivered from the instruction assigning unit for decoding the control lines of the assigned first encoding portions HEAD (step 130). Then the length of information included in the first encoding portions HEAD is employed to assign the second encoding portions TAIL (step 140). The assigned second encoding portions TAIL are decoded together (step 150). Through appropriate arrangement of the instruction field, the instruction field of each operand may align at a fixed position. Therefore, instruction decoding of the second encoding portions TAIL is merely done by obtaining the fields directly, and the critical paths are not affected.

According to the principle of the invention, an encoding method is provided for the usage rate of the very long instruction word architecture and instruction assignment. Two-layer HAT format encoding is employed. Each instruction package is directly placed in the instruction memory in sequence such that spotty bits caused by the super package are prevented. Furthermore, the bandwidth corresponding to the super package is not necessary for the instruction memory.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A encoding method for very long instruction word digital signal processing processor, comprising:
an instruction package CAP having encoding information;
a plurality of first encoding portions; and
a plurality of second encoding portions;
wherein the first encoding portions and the second encoding portions are compiled from an instruction, and the first encoding portions are arranged after the instruction package CAP in sequence, the second encoding portions are arranged after the first encoding portions in sequence.

2. The encoding method of claim 1, wherein the first encoding portion comprises length information of the second encoding portions.

3. The encoding method of claim 1, wherein the length of the first encoding portion is fixed.

4. The encoding method of claim 1, wherein the length of the second encoding portion is variable.

5. The encoding method of claim 1, wherein the instruction package CAP comprises general information.

6. The encoding method of claim 5, wherein the instruction package CAP occupies bytes with predetermined length.

7. The encoding method of claim 1, wherein the instruction package CAP is an version compatible package CAP having decoding ways such that the processor of new version may process the machine code of old version.

8. The encoding method of claim 1, wherein the instruction package is a program flow package having program executing flow.

9. The encoding method of claim 8, wherein the length of the instruction package CAP is less than or equal to bytes with predetermined length.

10. The encoding method of claim 8, wherein the instruction package CAP combines with the first encoding portions.

11. The encoding method of claim 1, wherein the instruction package is a data calculation package during interrupt.

12. The encoding method of claim 11, wherein the length of the instruction package CAP is less than or equal to bytes with predetermined length.

13. The encoding method of claim 11, wherein the instruction package CAP combines with the first encoding portions.

14. A decoding method for very long instruction word digital signal processing processor, comprising:
compiling at least one instruction including an instruction package CAP having encoding information, a plurality of first encoding portions, and a plurality of second encoding portions, wherein the first encoding portions and the second encoding portions are compiled from an instruction, and the first encoding portions are arranged after the instruction package CAP in sequence, the second encoding portions are arranged after the first encoding portions in sequence;
decoding the instruction package CAP having encoding information;
in one clock, assigning the plurality of the first encoding portions according to the decoded instruction package CAP, and generating program counter for next clock;
in another clock, decoding the assigned first encoding portions, and obtaining the length information of the first encoding portions; and
assigning the plurality of the second encoding portions according to the length information and decoding the second encoding portions.

15. The decoding method of claim 14, wherein the first encoding portion comprises length information of the second encoding portions.

16. The decoding method of claim 14, wherein the length of the first encoding portion is fixed.

17. The decoding method of claim 14, wherein the length of the second encoding portion is variable.

18. The decoding method of claim 14, wherein the instruction package CAP comprises general information.

19. The decoding method of claim 18, wherein the instruction package CAP occupies bytes with predetermined length.

20. The decoding method of claim 14, wherein the instruction package is an version compatible package having decoding ways such that the processor of new version may process the machine code of old version.

21. The decoding method of claim 14, wherein the instruction package is a program flow package having program executing flow.

22. The decoding method of claim 21, wherein the length of the instruction package CAP is less than or equal to bytes with predetermined length.

23. The decoding method of claim 21, wherein the instruction package CAP combines with the first encoding portions.

24. The decoding method of claim 14, wherein the instruction package is a data calculation package during interrupt.

25. The decoding method of claim 14, wherein the length of the instruction package CAP is less than or equal to bytes with predetermined length.

26. The decoding method of claim 14, wherein the instruction package CAP combines with the first encoding portions.
